(19) United States
(12) Patent Application Publication
(10) Pub. No.: US 2009/0074433 A1
(43) Pub. Date: Mar. 19, 2009

(54) IMAGE FORMING APPARATUS

(75) Inventor: Masahiro Doi, Tagata-gun (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/206,526

(22) Filed: Sep. 8, 2008

Related U.S. Application Data
(60) Provisional application No. 60/972,219, filed on Sep. 13, 2007.

(51) Int. Cl. G03G 21/12

(52) U.S. Cl. 399/35

(57) ABSTRACT

An embodiment according to the invention is characterized in that a result of a fill-up detection of a waste toner in a housing container which is detected by a toner sensor is compensated for based on total image formation or a period in which an image forming apparatus is operated.

### CROSS-REFERENCE TO RELATED APPLICATIONS

This application is based upon and claims the benefit of U.S. Provisional Application No. 60/972,219 filed on Sep. 13, 2007, the entire contents of each of which are incorporated herein reference.

### TECHICAL FIELD

The present invention relates to an image forming apparatus capable of obtaining a copy image of an object and a print out corresponding to image information.

### BACKGROUND

For an image forming apparatus which uses, as a recording material (a sheet material), a general plain paper which is not subjected to a special processing, image forming apparatuses utilizing various methods such as an electrophotographing method, an ink jet method and a thermal transfer method already spread widely. The image forming apparatus is changed to be multifunctional in accordance with a diversification of a request given from a user, and is currently referred to as a Multi-Functional peripheral (MFP).

In the MFP using the electrophotographing method, a latent image is visualized through a visualizing material which is referred to as a toner. In the electrophotographing method, the toner is selectively positioned on an output medium.

A part of the toner remains on a latent image holding member (without the transfer). A collecting mechanism collects the toner remaining on the latent image holding member. A housing container stores the toner collected by the collecting mechanism.

For example, JP-A-2004-205590 describes an example in which the toner collected by a toner collecting tank is detected by means of a sensor and a host computer recognizes that the toner collecting tank is filled up only when the number of dots of image data which is counted by a dot number counter reaches a predetermined value.

### SUMMARY

According to an aspect of the present invention, there is provided an image forming apparatus including a photoconductor which holds a latent image, a developing device which supplys a toner to the latent image to carry out a development, a transfer device which transfers, onto a sheet material, a toner image obtained by developing the latent image through the developing device, a collector which collects the toner remaining on the transfer device, a housing which stores the toner collected by the collector, a detector which detects that the toner collected by the collector is present in a predetermined amount or more in the housing, a compensator which counts a predetermined number of times of image formation, and a determination device which determinates that the housing is filled with the toner based on the number of times of image formation detected by the compensator when the detector detects that the toner collected by the collector is present in a predetermined amount or more for an exchange of the housing in the housing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an example of an image forming apparatus (a Multi-Functional Peripheral (MFP)) to which an embodiment of the invention is applied;

FIG. 2 is a view showing a state in which an ADU including a toner collecting mechanism and a housing portion in a transfer device of the MFP illustrated in FIG. 1 is released;

FIG. 3 is a view showing the toner collecting mechanism and the housing portion in the transfer device illustrated in FIG. 2;

FIG. 4 is a view showing the toner collecting mechanism illustrated in FIG. 3;

FIG. 5 is a view showing an example in which the housing portion is connected to the toner collecting mechanism of the transfer device illustrated in FIG. 2;

FIG. 6 is a view showing a state of the housing portion which is brought subsequently to the state illustrated in FIG. 5;

FIG. 7 is a view showing an example of a structure in which a sensor is connected to the housing portion illustrated in FIG. 5 or 6; and

FIG. 8 is a diagram schematically showing a control system of the MFP illustrated in FIGS. 1 to 7.

### DETAILED DESCRIPTION

An embodiment of the present invention is explained in detail below with reference to the accompanying drawings.

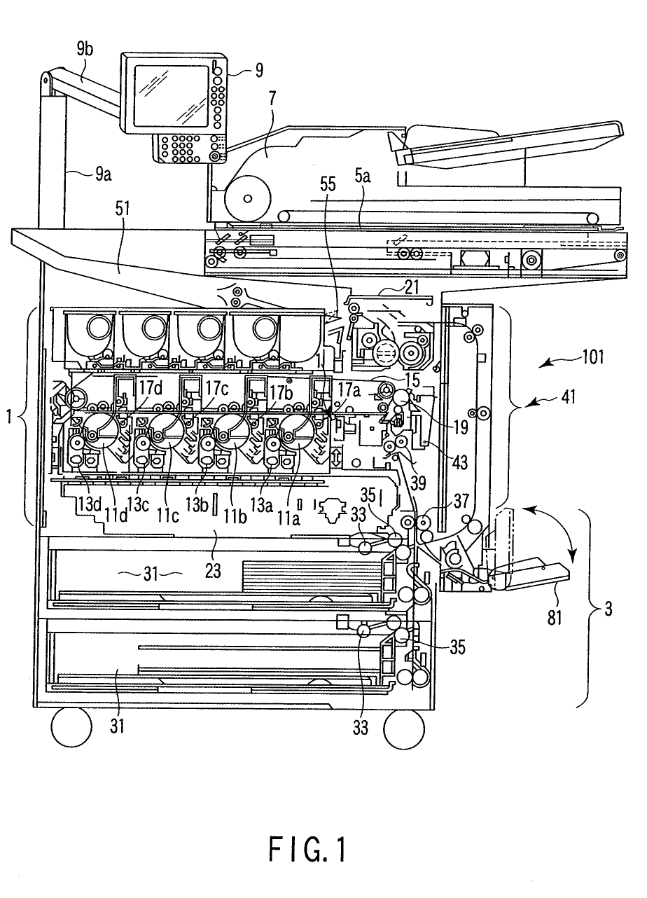

FIG. 1 schematically shows an image forming apparatus (MFP, Multi-Functional Peripheral) to which the invention can be applied.

An image forming apparatus 101 shown in FIG. 1 has an image forming section body 1 for outputting image information as an output image which is referred to as a hard copy or a print out, for example, a paper supplying section 3 capable of supplying, to the image forming section body 1, a paper (an output medium) having an optional size which is used for an image output, and an image reading section 5 for taking, as image data, image information to be an image forming object in the image forming section body 1 from an object holding the image information (which will be hereinafter referred to as an original).

The image reading section 5 includes an original table (an original glass) 5a for supporting an object and an image sensor for converting the image information into image data, for example, a CCD sensor, which will not be described in detail. The image reading section 5 converts a reflected light into an image signal through the CCD sensor. The reflected light is obtained by irradiating a light from an illuminating apparatus (not shown) onto the original set into the original table 5a.

Moreover, the image reading portion 5 integrally has an automatically-document feeder (ADF) 7 for discharging a read original from a reading position to a discharging position and guiding a next original to a reading position after a formation of an image output or taking of image information (hereinafter referred to as a read) is ended when the original is a sheet. In place of the ADF 7, a general original cover may be used, which is not shown. Furthermore, the CCD sensor of the image reading portion 5 may be positioned in an optional position in a delivery path through which the original is delivered in the ADF 7 independently of the original table 5a. The CCD sensor placed in an optional position in the delivery path through which the original is delivered independently of the original table 5a reads, as image data, image information included in the original during the delivery without the original positioned on the original table.

An instruction input section for giving an instruction for starting image formation in the image forming section body 1 and starting to read image information of the original through the image reading section 5, that is, a control panel (operating section) 9 is placed in a strut 9a (fixed to the image forming portion body 1) and a swing arm 9b in a corner at a left or right side behind the image reading portion 5, for example or the like.

The image forming section body 1 includes first to fourth photoconductive drums 11a to 11d for holding latent images, developing devices 13a to 13d for supplying a developer, that is, a toner to the latent images held by the photoconductive drums 11a to 11d and carrying out a development, a transfer belt 15 for holding toner images held by the photoconductive drums 11a to 11d in order, cleaners 17a to 17d for removing the toner remaining on the photoconductive drums 11a to 11d from the individual photoconductive drums 11a to 11d, a transfer device 19 for transferring the toner image held by the transfer belt 15 onto a plain paper or a sheet-like transfer medium (hereinafter referred to as a sheet material) such as an OHP sheet to be a transparent resin sheet, a fuser device 21 for fixing the toner image transferred to the sheet material by the transfer device 19 onto the sheet material, and an exposing device 23 for forming latent images on the photoconductive drums 11a to 11d and the like.

The first to fourth developing devices 13a to 13d store toners having optional colors of Y (yellow), M (magenta), C (cyan) and Bk (black) which are used for obtaining a color image by a subtractive process and visualize a latent image held by each of the photoconductive drums 11a to 11d in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developing devices 13a to 13d in order (of the formation of the toner images).

The paper supply section 3 supplies, in a predetermined timing, the sheet material to be used for transferring the toner image by the transfer device 19.

Cassettes positioned in a plurality of cassette slots 31 which will not be described in detail store sheet materials having optional sizes. Depending on an image forming operation which will not be described in detail, a pickup roller 33 takes the sheet material out of the corresponding cassette. The size of the sheet material corresponds to a size of the image of the developer formed by the image forming section body 1.

A separating mechanism 35 prevents at least two sheet materials from being taken out of the cassette by the pickup roller 33.

A plurality of delivery rollers 37 feed the sheet material separated to be one sheet by the separating mechanism 35 toward an aligning roller 39.

The aligning roller 39 feeds the sheet material to a transfer position in which the transfer device 19 and the transfer belt 15 come in contact with each other in a timing for transferring the image of the developer from the transfer belt 15 by the transfer device 19.

The fuser device 21 fixes the image of the developer (toner) corresponding to the image information onto the sheet material, that is, the output image (hard copy, print out) and feeds the output image to a stock section 51 positioned in a space between the image reading section 5 and the image forming section body 1.

The transfer device 19 is positioned in an automatically-duplex unit (ADU) 41 for replacing both sides of the sheet material, that is, the output image (hard copy, print out) which has the toner image fixed thereto by the fuser device 21. A bypass tray 81 is attached to the ADU 41.

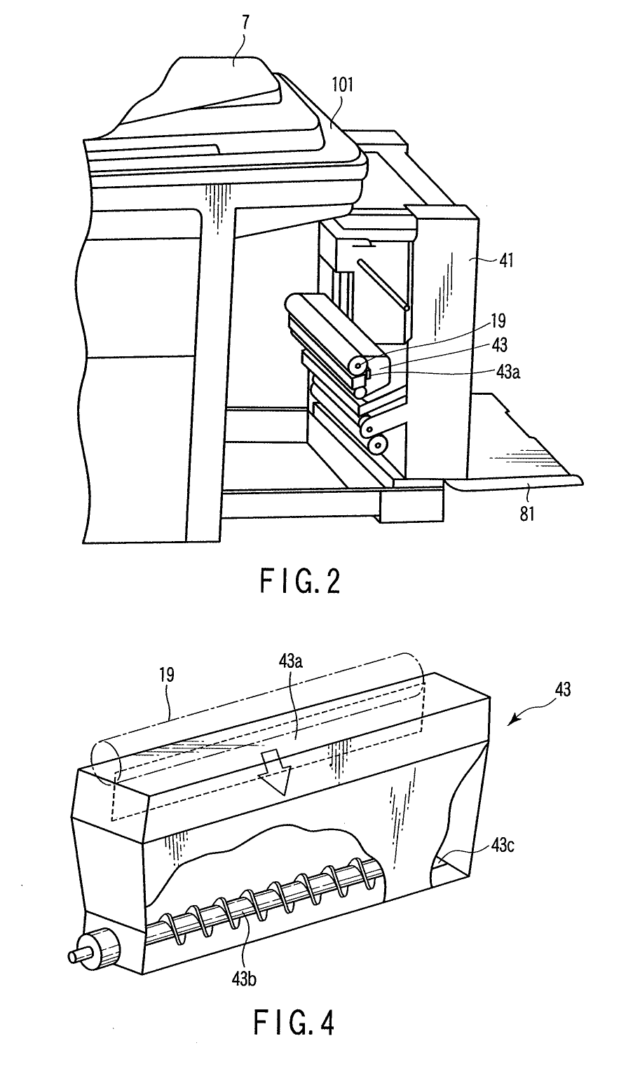

As shown in FIG. 2, the ADU 41 moves to a side (a right side) with respect to the image forming section body 1 when the sheet material is jammed between the delivery roller 37 (a final one) and the aligning roller 39 or between the aligning roller 39 and the fuser device 21, that is, in the transfer device 19 or the fuser device 21. The ADU 41 integrally has a cleaner 43 for cleaning the transfer device 19.

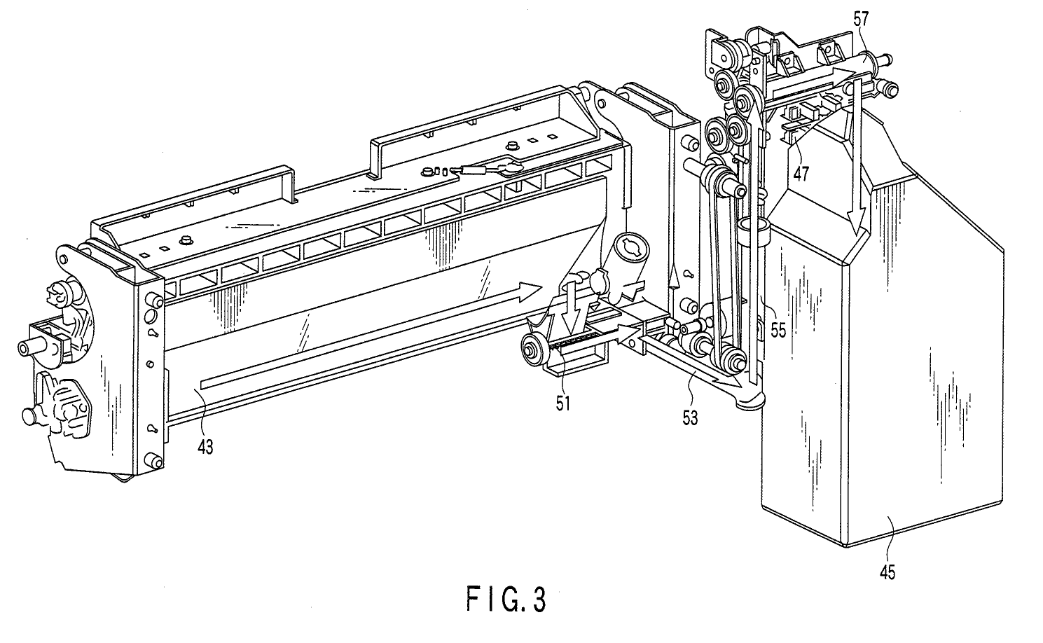

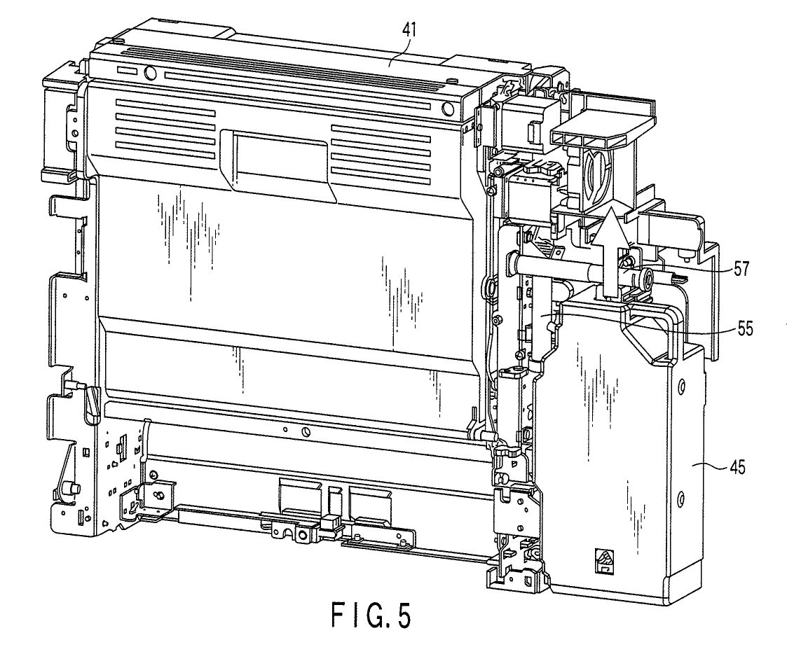

As shown in FIGS. 3 and 4, the cleaner 43 includes a cleaning blade 43a for removing the toner sticking to the transfer device 19 and an auger 43b. The auger 43b generates a thrust for moving the toner removed from the transfer device 19 by the blade 43a from a connecting portion 43c to a waste toner housing container 45.

The first moving mechanism 51 is connected to the connecting portion 43c of the cleaner 43 and moves the waste toner in the cleaner 43 toward the waste toner housing container 45. Second to fourth moving mechanisms 53, 55 and 57 transport the waste toner from the first moving mechanism 51 to the waste toner housing container 45. If the first to fourth moving mechanisms 51, 53, 55 and 57 can move the waste toner (powder), their configurations and structures are optional.

The waste toner housing container 45 detects that the container 45 is filled with the waste toner delivered by the fourth moving mechanism 57. The waste toner housing container 45 includes a sensor holding section 45a integrated with a fill-up sensor 47 in the vicinity of a portion to which the waste toner is supplied through the fourth moving mechanism 57.

The fill-up sensor 47 is of a well-known optical type which has a light transmitting section (a light source) and a light receiving section (a photodetector) at a predetermined interval. The fill-up sensor 47 may detect an electrostatic capacity.

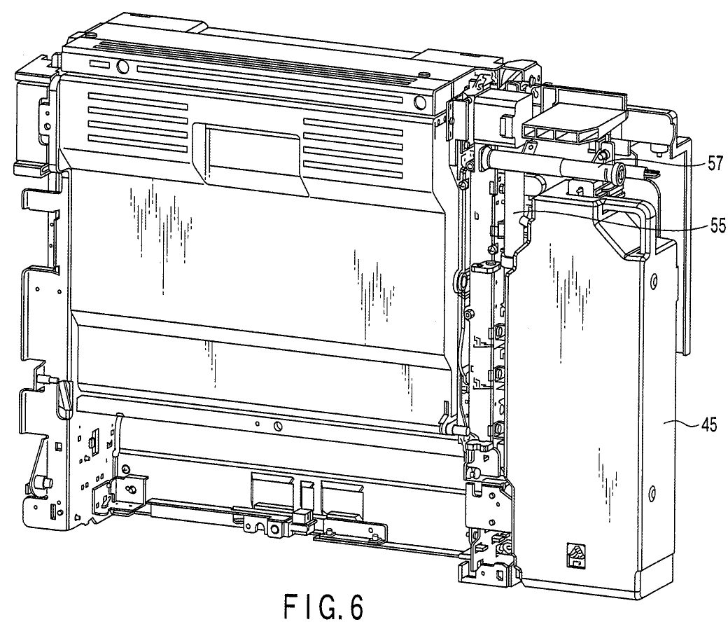

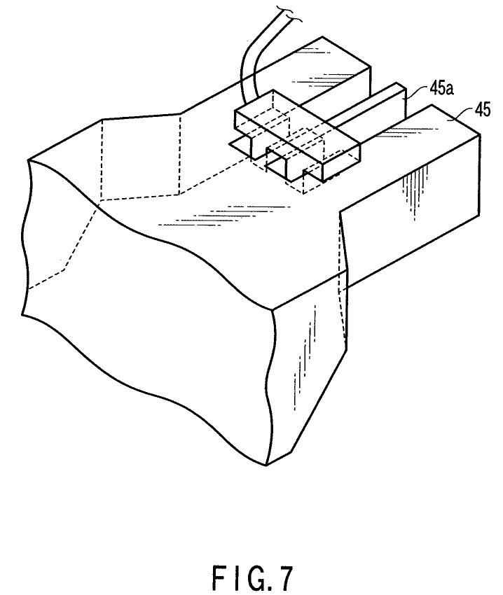

When the waste toner housing container 45 is to be attached to the image forming apparatus 101, it slides in a longitudinal direction as shown in FIGS. 5 and 6. The sensor holding section 45a does not disturb the sliding operation of the fill-up sensor 47.

As shown in FIG. 7, the fill-up sensor 47 is placed in a position in which the removal of the waste toner housing container 45 from the image forming apparatus 101 is not disturbed. The fill-up sensor 47 is placed in a position in which the attachment of the waste toner housing container 45 to the image forming apparatus 101 is not disturbed. A direction of the fill-up sensor 47 (in a fixation) permits various mounting configurations of the waste toner housing container 45 in the image forming apparatus 101. The fill-up sensor 47 may include a contact section for applying a predetermined pressure between the fill-up sensor 47 and the waste toner housing container 45. The waste toner housing container 45 may include the contact section for applying a predetermined pressure between the waste toner housing container 45 and the fill-up sensor 47. The contact is allowed to be positioned in at least one of the waste toner housing container 45 and the fill-up sensor 47.

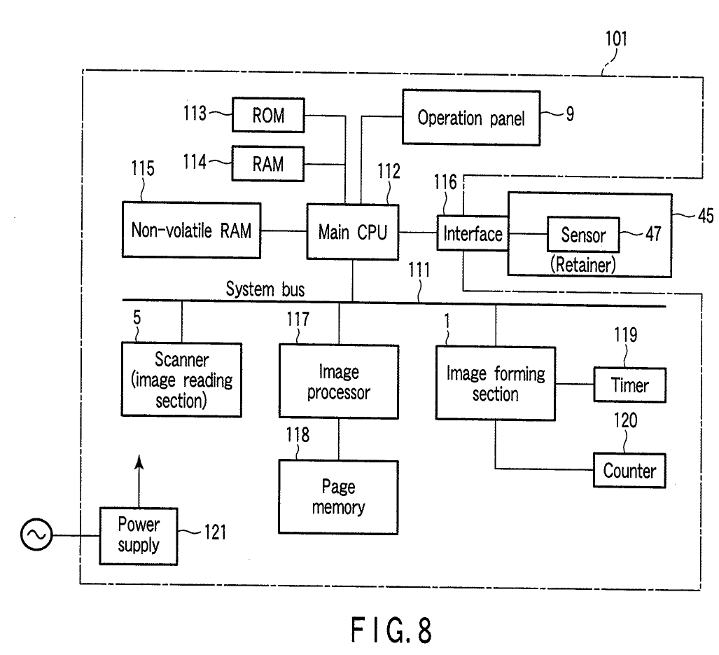

FIG. 8 shows an element for compensating for the fill-up of the toner in the housing container which is detected by the toner (fill-up) sensor.

The image forming apparatus (MFP) 101 includes a system bus line 111. The system bus line 111 connects a main control block, that is, a main CPU 112 for processing image information of an object to be outputted by an image forming section 1 including the scanner (image reading section) 5 and an image processor 117, and the image forming section 1. The main control block 112 connects an ROM (Read Only Memory) 113, an RAM (Random Access Memory) 114, and a non-volatile RAM 115 for storing a total number of times of image formation, a total operating (working) time or the like, an interface 116 for inputting an output of the toner sensor 47 to the main control block 112, and the operation panel 9. The image processor 117 connects a page memory 118. The image forming section 1 counts a timer 119 for counting a time required for connecting a commercial power to a power supply 122, and a counter 120 for counting the number of the image forming operations of the image forming section 1 (the number of the outputs of the print out). More specifically, it is also possible to compensate for the influence of the JAM. Some count values are varied in accordance with the size of the paper (sheet material). The count value of A3 is a double of that of A4.

In the case in which the fill-up sensor 47 detects that the waste toner housing container 45 is filled with the toner, the main control block 112 disregards a result of the detection of the fill-up sensor 47 until the counter 120 detects the end of the image formation at a predetermined number of times (number of sheets).

Even if the fill-up sensor 47 detects that the waste toner housing container 45 is filled with the toner, the main control block 112 resets an integration through the counter 120 to count the number of times of image formation again when the output of the sensor 47 is turned OFF before the counter 120 detects the end of the image formation at a predetermined number of sheets (number of times).

The main control block 112 holds the output of the fill-up sensor 47 for a predetermined period (a total number of times of image formation or a duration of power-ON) to compensate for an influence of toner scattering in the waste toner housing container 45.

In the case in which the fill-up sensor 47 detects the fill-up of the toner in the waste toner housing container 45 and a power supply 121 is turned OFF while the counter 120 counts a total predetermined number of times of the subsequent image formation, the non-volatile RAM 115 holds a count value of the counter 120.

When the power supply 121 is connected to a commercial power in order to carry out a next operation of the image forming apparatus 101, the main control block 112 reads the total number of times of image formation (output) or a total operating (working) time which is held by the non-volatile RAM 115 and compensates for the total number of times of image formation (the total operating time) after the fill-up sensor 47 detects that the housing container 45 is filled with the waste toner.

The image forming apparatus according to the embodiment of the invention prevents the detection of fill-up before the container for storing the waste toner is filled up.

Moreover, the container of the image forming apparatus according to the embodiment of the invention is reliably filled with the waste toner. Therefore, the container substantially prevents the necessity of an exchange for a life cycle in which the developing device and the photoconductive drum need to be exchanged.

Furthermore, the image forming apparatus according to the embodiment of the invention causes an exchange timing of the waste toner housing container to be appropriate. Therefore, a running cost can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a photoconductor which holds a latent image;
a developing device which supplys a toner to the latent image to carry out a development;
a transfer device which transfers, onto a sheet material, a toner image obtained by developing the latent image through the developing device;
a collector which collects the toner remaining on the transfer device;
a housing which stores the toner collected by the collector;
a detector which detects that the toner collected by the collector is present in a predetermined amount or more in the housing;
a compensator which counts a predetermined number of times of image formation; and
a determination device which determinates that the housing is filled with the toner based on the number of times of image formation detected by the compensator when the detector detects that the toner collected by the collector is present in a predetermined amount or more for an exchange of the housing in the housing.

2. The apparatus of claim 1, wherein the determination device (the main control block 112) is operated based on a result of the detection of the detector when the detector continuously detects that an inner part of the housing is filled with the toner for a certain period in which a compensation is to be carried out by the compensator.

3. The apparatus of claim 1, wherein the compensator counts the number of outputs of the sheet material holding the toner image.

4. The apparatus of claim 1, wherein the compensator corrects the number of times of image formation based on a size of the toner image.

5. The apparatus of claim 1, wherein the compensator includes a timer counting a time required for operating the image forming apparatus for image formation.

6. The apparatus of claim 1, further comprising:
a non-volatile memory which stores a past result of counts of the compensator when a connection of a power section to a commercial power is turned OFF while the compensator counts the number of times of image formation.

7. The apparatus of claim 6, wherein the compensator counts the number of outputs of the sheet material holding the toner image.

8. The apparatus of claim 6, wherein the compensator corrects the number of times of image formation based on a size of the toner image.

9. The apparatus of claim 2, wherein the compensator counts the number of outputs of the sheet material holding the toner image.

10. The apparatus of claim 2, wherein the compensator corrects the number of times of image formation based on a size of the toner image.

11. The apparatus of claim 2, wherein the compensator includes a timer counting a time required for operating the image forming apparatus for image formation.

12. The apparatus of claim 2, further comprising:
a non-volatile memory which stores a past result of counts of the compensator when a connection of a power section to a commercial power is turned OFF while the compensator counts the number of times of image formation.

13. The apparatus of claim 12, wherein the compensator counts the number of outputs of the sheet material holding the toner image.

14. The apparatus of claim 12, wherein the compensator corrects the number of times of image formation based on a size of the toner image.

15. A waste toner detecting mechanism comprising:
a sensor which detects a presence of a toner in accordance with an amount of a transmitted light;
a counter which counts the number of sheets of image formation; and
a waste toner detecting mechanism which determinates a fill-up detection of a waste toner housing container only when a sensor detection output is not turned OFF before a predetermined number of sheets of image formation is counted by the counter and resetting the count in the counter to avoid a sensor false detection due to toner scattering in the waste toner housing container when the sensor detection output is turned OFF while the predetermined number of sheets of image formation is counted.

16. A waste toner detecting mechanism comprising:
a sensor which detects a presence of a toner in accordance with an amount of a transmitted light;
a counter counts the number of sheets of image formation; and
a waste toner detecting mechanism which detects a continuation of a sensor detection output to determine a fill-up detection of a waste toner housing container while the counter counts a predetermined number of sheets of image formation, and resetting the count in the counter to consecutively store a waste toner in the waste toner housing container when the sensor detection output is turned OFF while the predetermined number of sheets of image formation is counted.

17. A waste toner detecting method comprising:
detecting a presence of a toner in accordance with an amount of a transmitted light;
counting the number of sheets of image formation; and
determining a fill-up detection of a waste toner housing container when the presence of the toner is continuously detected before a predetermined number of sheets of image formation is counted, and resetting the count to avoid a sensor false detection due to toner scattering in the waste toner housing container when a detection output of the presence of the toner is turned OFF before the predetermined number of sheets of image formation is counted.

18. A waste toner detecting method comprising:
detecting a presence of a toner in accordance with an amount of a transmitted light;
counting the number of sheets of image formation; and
detecting that a sensor detection output continuously indicates the presence of the toner and determines a fill-up detection of a waste toner housing container while a predetermined number of sheets of image formation is counted, and resetting the count to consecutively store a waste toner in the waste toner housing container when the detection output indicative of the presence of the toner is turned OFF while the predetermined number of sheets of image formation is counted.
